(19) United States
(12) Patent Application Publication
(10) Pub. No.: US 2025/0214665 A1
(43) Pub. Date: Jul. 3, 2025

(54) REPLACEABLE PART REPLACEMENT SYSTEM FOR A VEHICLE

(71) Applicants: HYUNDAI MOTOR COMPANY, Seoul (KR); KIA CORPORATION, Seoul (KR)

(72) Inventors: Jaeseung Lee, Hwaseong-si (KR); Joonghyun Shin, Hwaseong-si (KR); Won Ki Song, Hwaseong-si (KR); Hyungsik Choi, Hwaseong-si (KR); Dae Hee Lee, Hwaseong-si (KR); Jin Ho Hwang, Hwaseong-si (KR); Soo Bok Kim, Hwaseong-si (KR); Sun Hyung Cho, Hwaseong-si (KR); Choon Taik Kim, Yongin-si (KR)

(73) Assignees: HYUNDAI MOTOR COMPANY, Seoul (KR); KIA CORPORATION, Seoul (KR)

(21) Appl. No.: 18/963,172

(22) Filed: Nov. 27, 2024

(30) Foreign Application Priority Data
Dec. 28, 2023 (KR) 10-2023-0194787

(51) Int. Cl. B62D 65/02; B08B 3/02

(52) U.S. Cl. CPC B62D 65/024; B08B 3/02; B08B 2203/02

(57) ABSTRACT

A replaceable part replacement system for a vehicle includes: a station frame on which a vehicle, including a fixed part fixed to an under body and a replaceable part removable from the fixed part, is positioned; a support frame installed on the station frame to be movable along the forward and backward direction of the vehicle; and a gripper unit installed in the support frame to be movable in the vertical direction for gripping and releasing the replaceable part.

### CROSS-REFERENCE TO RELATED APPLICATION

This application claims priority to and the benefit of Korean Patent Application No. 10-2023-0194787 filed in the Korean Intellectual Property Office on Dec. 28, 2023, the entire contents of which are incorporated herein by reference.

### BACKGROUND

### (a) Technical Field

The present disclosure relates to a replaceable part replacement system for a vehicle. More particularly, the present disclosure relates to a replaceable part replacement system for a vehicle that is configured to replace a replaceable part that can be changed according to a purpose of use.

### (b) Description of the Related Art

Recently, the vehicle industry is introducing a new concept of future mobility technology for realizing a human-centered, dynamic future city. One of these future mobility solutions is a Purpose Built Vehicle (PBV) as a purpose-based mobility vehicle.

An example of a PBV is an electric vehicle (EV)-based environmentally-friendly mobility vehicle. These PBVs can provide various customized services to users.

The vehicle body of the PBV has an upper body assembled to an under body. The upper body can be manufactured in various shapes depending on the type of customized service provided to the user.

However, if the upper body structure is developed separately depending on the type of customized service provided to the user as described above, the production cost may increase.

Accordingly, PBVs that can increase vehicle utilization while reducing production costs are being developed more recently.

For example, a vehicle is being developed that has a common configuration for the cabin in the front part of the upper body, including the driver's seat, and for the underbody, and that has a configuration that can change the rear part of the upper body to suit the user's purpose.

The front part of the vehicle can be defined as a fixed part (fixed portion) that is fixed to the front part of the under body. Additionally, the rear part of the vehicle can be defined as a replaceable part (replaceable portion) manufactured in various shapes depending on the intended use of the vehicle.

The fixed part is a component that is not replaced even if the vehicle's intended use changes. The replaceable part is a component that can be replaced depending on the purpose of use of the vehicle. The replaceable part can be combined with the fixed part and the rear part of the under body, or can be separated from the fixed part and the rear part of the under body.

To this end, the vehicle industry is focusing on developing replaceable part exchange solutions that allow replaceable parts to be easily replaced in the field depending on the vehicle's intended use.

The information contained in this background section has been prepared to promote understanding of the background of the present disclosure and may include subject matter that is not prior art already known to those having ordinary skill in the art.

### SUMMARY

The present disclosure provides a replaceable part replacement system for a vehicle that allows for easy replacement of replaceable parts in the field with a simple configuration depending on the intended use of the vehicle.

A replaceable part replacement system for a vehicle according to an embodiment of the present disclosure may include: a station frame on which a vehicle, including a fixed part fixed to an under body and a replaceable part removable from the fixed part, is positioned; a support frame installed on the station frame to be movable along the forward and backward direction of the vehicle; and a gripper unit installed in the support frame to be movable in the vertical direction for gripping and releasing the replaceable part.

The replaceable part replacement system for a vehicle according to a disclosure may further include a moving unit installed on the station frame and connected to the support frame to move the support frame along the forward and backward direction of the vehicle.

The station frame may include a station body having an internal space and a station base connected to the upper part of the station body to support the vehicle.

The support frame may include: at least one vertical frame that is connected to a moving unit installed in the internal space of the station body and that extends upward through a slot formed in the station base; at least one horizontal frame connected in the horizontal direction to the at least one vertical frame; and a mounting plate (also referred to as ‘mount plate’) attached to at least one horizontal frame. The gripper unit may be mounted on the mounting plate.

The moving unit may include at least one guide rail arranged along the forward and backward direction of the vehicle on the station frame and may include a moving plate connected to a first driver installed in the station frame, slidably installed on the at least one guide rail, and connected to the support frame.

The moving unit may further include at least one slider fixed to the moving plate and slidably connected to at least one guide rail.

The gripper unit may include a gripper moving member connected to a second driver installed in the support frame and mounted on the support frame to be movable in the vertical direction and may include at least one gripper module installed on the gripper moving member to be coupled with at least one gripper connecting portion provided on the replaceable part.

The at least one gripper connecting portion may be an armature block of a steel material connected to a roof of the replaceable part.

The at least one gripper module may be a magnetic module that can be coupled to the armature block by electromagnetic force.

The at least one gripper module may include a mounting bracket connected to the support frame, a magnetic holder mounted via a magnetic bracket to the mounting bracket, and a coil wound on the magnetic holder.

The at least one gripper module may further include a guide bushing connected to the mounting bracket and a floating rod connected to the guide bushing to be movable in the vertical direction. The floating rod may be connected to the magnetic bracket.

The at least one gripper module may further include a stopper block provided on the upper part of the guide bushing and connected to the floating rod.

The at least one gripper module may further include a damping member mounted on the floating rod between the guide bushing and the magnetic bracket.

The damping member may be a compression coil spring.

The replaceable part may be provided with at least one gripper connecting portion that is gripped by the gripper unit. The replaceable part replacement system may further include a cleaning module installed in the gripper unit to spray washer fluid onto at least one gripper connecting portion.

The cleaning module may include a cleaning nozzle configured to spray water stored in a water tank to at least one gripper connecting portion by compressed air provided from a compressor.

The vehicle may be a PBV (Purpose Built Vehicle).

According to the replaceable part replacement system for a vehicle according to embodiments of the present disclosure, it is possible to produce PBVs that provide various customized services to users, increase the utilization of PBVs, and secure standardization and competitive advantage of future new businesses utilizing PBVs.

In addition, the effects that can be obtained or expected from embodiments of the present disclosure are directly or implicitly disclosed in the detailed description of embodiments of the present disclosure. In other words, various effects predicted according to embodiments of the present disclosure are disclosed in the detailed description to be provided below.

### BRIEF DESCRIPTION OF THE DRAWINGS

Since the drawings are for reference in explaining embodiments of the present disclosure, the technical idea of the present disclosure should not be construed as being limited to the accompanying drawings.

FIG. 1 is a block diagram illustrating an example of a vehicle to which a replaceable part replacement system according to an embodiment of the present disclosure can be applied.

FIG. 2 is a perspective view illustrating a replaceable part replacement system of a vehicle according to an embodiment of the present disclosure.

FIG. 3 is a side view illustrating a replaceable part replacement system of a vehicle according to an embodiment of the present disclosure.

FIG. 4 is a rear view illustrating a replaceable part replacement system of a vehicle according to an embodiment of the present disclosure.

FIG. 5 is a perspective view illustrating a moving unit applied to a replaceable part replacement system of a vehicle according to an embodiment of the present disclosure.

FIG. 6 is a partially exploded perspective view illustrating a moving unit applied to a replaceable part replacement system for a vehicle according to an embodiment of the present disclosure.

FIG. 7 is a perspective view illustrating a gripper unit applied to a replaceable part replacement system of a vehicle according to an embodiment of the present disclosure.

FIG. 8 is a front view illustrating a gripper unit applied to a replaceable part replacement system of a vehicle according to an embodiment of the present disclosure.

FIG. 9 is a perspective view illustrating a gripper module of a gripper unit applied to a replaceable part replacement system of a vehicle according to an embodiment of the present disclosure.

FIG. 10 is a front view illustrating a gripper module of a gripper unit applied to a replaceable part replacement system of a vehicle according to an embodiment of the present disclosure.

FIGS. 11A and 11B are drawings illustrating the operation of a replaceable part replacement system for a vehicle according to an embodiment of the present disclosure.

FIG. 12 is a front view illustrating a replaceable part replacement system of a vehicle according to another embodiment of the present disclosure.

FIG. 13 is a drawing illustrating the operation of a replaceable part replacement system for a vehicle according to another embodiment of the present disclosure.

The drawings referenced above are not necessarily drawn to scale. Thus, the drawings should be understood as presenting a somewhat simplified representation of various features illustrating the basic principles of the present disclosure. The specific design features of the present disclosure, including, for example, specific dimensions, orientation, location, and shape, will be determined in part by the particular intended application and usage environment.

### DETAILED DESCRIPTION

Hereinafter, with reference to the attached drawings, embodiments of the present disclosure are described in detail so that those having ordinary skill in the art can implement the present disclosure. As those having ordinary skill in the art would realize, the described embodiments may be modified in various different ways, all without departing from the spirit or scope of the present disclosure.

The terminology used herein is for the purpose of describing embodiments only and is not intended to limit the present disclosure. As used herein, the singular forms are intended to include the plural forms as well, unless the context clearly indicates otherwise.

It should also be understood that the terms “comprise,” “include,” “have,” their variations “comprising,” “including,” “having,” and the like as used herein indicate the presence of stated features, integers, steps, operations, elements and/or components, but do not preclude the presence or addition of one or more other features, integers, steps, operations, components, and/or groups thereof.

As used herein, the term ‘and/or’ includes any and all combinations of one or more of the associated listed items.

The term ‘connected’ in this specification denotes a physical relationship between two components that are directly connected to each other or indirectly connected through one or more intermediary components.

Furthermore, as used herein, the term “operably connected” or similar terms means that at least two members are directly or indirectly connected to each other so as to be capable of transmitting power. However, two operatively connected members do not always rotate at the same speed and in the same direction.

As used herein, ‘vehicle’, ‘vehicular’, ‘automotive’ or other similar terms as used herein generally refer to passenger vehicles, sports cars, sport utility vehicles (SUVs), buses, trucks. Such terms also may generally refer to various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources).

When a component, unit, part, member, device, element, apparatus, or the like of the present disclosure is described as having a purpose or performing an operation, function, or the like, the component, unit, part, member, device, element, apparatus, or the like should be considered herein as being “configured to” meet that purpose or to perform that operation or function.

Hereinafter, embodiments of the present disclosure are described in detail with reference to the attached drawings.

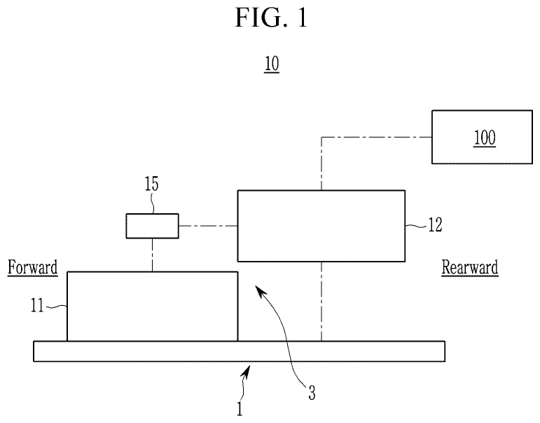

FIG. 1 is a block diagram illustrating an example of a vehicle to which a replaceable part replacement system according to an embodiment of the present disclosure can be applied.

Referring to FIG. 1, a vehicle 10 to which embodiments of the present disclosure may be applied may, for example, be a purpose-based mobility vehicle (Purpose Built Vehicle: hereinafter referred to as ‘PBV’).

The vehicle body of such a PBV includes a skateboard type under body 1 (commonly referred to as a ‘rolling chassis’ or ‘chassis frame’ by those having ordinary skill in the art) and an upper body 3 assembled to the under body 1.

The upper body 3 may be configured in various shapes depending on the intended use of the PBV.

For example, the PBV can be used as a hailing vehicle or a high roof vehicle with cabins configured in the front and rear of the upper body, respectively. The PBV can also be used as a delivery vehicle with a cabin in the front part of the upper body and a luggage room in the rear part. The PBV can be used as a pick-up vehicle or chassis cap vehicle with a cabin in the front and a deck in the rear.

In this specification, the reference direction for describing the components below may be set as the front-rear direction of the vehicle 10 (e.g., the length direction or longitudinal direction of the vehicle), the vehicle width direction of the vehicle 10 (e.g., the transverse direction), and the vehicle vertical direction (e.g., the height direction or up down direction).

In this specification, ‘upper end’, ‘upper portion’, or ‘upper surface’ of a component indicates an end, portion, or surface of a component that is relatively upper in the drawing, and ‘lower end’, ‘ lower portion’, or ‘ lower surface’ of a component indicates an end, portion, or surface of a component that is relatively lower in the drawing.

Furthermore, in this specification, an end of a component (e.g., one end or another (other) end, and the like) denotes an end of a component in any one direction, and an end portion of the component (e.g., one end portion) or other (another) end portion, and the like) denotes a portion of a component that includes that end.

A vehicle 10 (e.g., PBV) to which a replaceable part replacement system 100 according to an embodiment may be applied includes an upper body 3 assembled to an under body 1, and the upper body 3 includes a fixed part 11 (fixed portion) and a replaceable part 12 (replaceable portion).

The fixed part 11 is a front part of the upper body 3 and is fixed to the front part of the under body 1. The fixed part 11 includes a front cabin of cab type.

The fixed part 11 may be attached to the front part of the under body 1 along the vertical direction via a vehicle body mounting unit known to those having ordinary skill in the art. The fixed part 11 here is defined in an embodiment and claim as a configuration that is not replaced even if the intended use of vehicle 10 changes.

The replaceable part 12 is the rear part of the upper body 3 and may be manufactured in various shapes depending on the intended use of the vehicle 10. For example, the replaceable part 12 includes a rear cabin, luggage room, or deck. The replaceable part 12 herein is defined as a replaceable configuration depending on the intended use of the vehicle 10.

The replaceable part 12 may be connected to the rear part of the under body 1 and the fixed part 11 by a joint unit 15. The replaceable part 12 may be separated from the rear part of the under body 1 and the fixed part 11.

The joint unit 15 may be configured for various types of joints, such as a configuration that is manually connected by a mechanical configuration, a configuration that is connected by the operation of a separate actuator, and a configuration that may be connected and/or disconnected depending on the supply of external or internal power, including magnetic, and the like. The configuration and operation of the joint unit 15, which connects or disconnects one or more modules or frames, should be apparent to those having ordinary skill in the art, and thus a detailed description therefor has been omitted.

The replaceable part replacement system 100 of a vehicle according to an embodiment provides a structure that allows easy replacement of a replaceable part 12 in the field, which can be changed depending on the intended use of the vehicle 10.

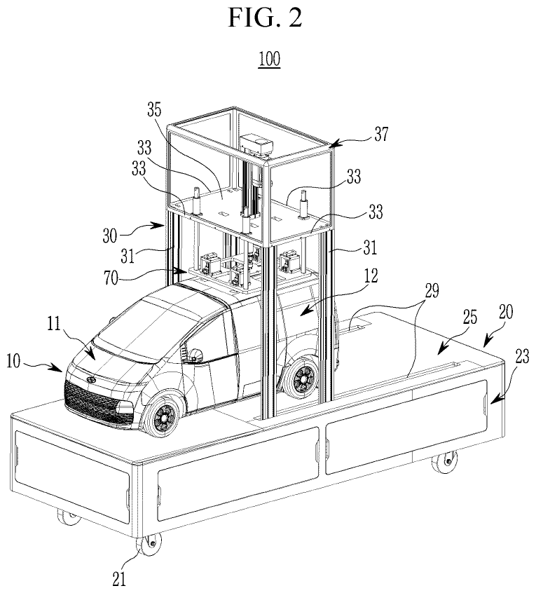

FIG. 2 is a perspective view illustrating a replaceable part replacement system of a vehicle according to an embodiment.

Referring to FIG. 2, the replaceable part replacement system 100 for a vehicle according to an embodiment includes a station frame 20, a support frame 30, and a gripper unit 70.

In an embodiment, the station frame 20 is configured to support various components as described below. The station frame 20 may be one frame or two or more connected frames.

Additionally, the station frame 20 may include various auxiliary elements such as rods (or beams), plates, brackets, and blocks to support various components.

Since the above-mentioned various auxiliary elements are for installing various components in station frame 20, in an embodiment, except in exceptional cases, the above-mentioned auxiliary elements are collectively referred to as station frame 20.

The station frame 20 is configured to position the vehicle 10 that has been brought into the field work area (e.g., replaceable part exchange location).

The vehicle 10 with the fixed part 11 fixed to the front part of the under body 1 and the replaceable part 12 connected to the rear part of the under body 1 and the fixed part 11 is positioned on the station frame 20 by the joint unit 15.

The station frame 20 can be equipped with a box frame type. Such a station frame 20 may, in one example, be fixed in a static manner to a field work site. In another example, the station frame 20 may be freely moved within the field work area by a plurality of casters 21 mounted underneath, as shown in the drawing.

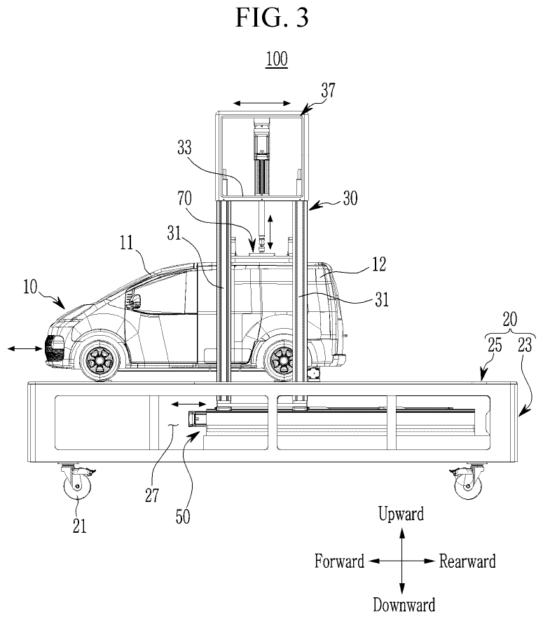

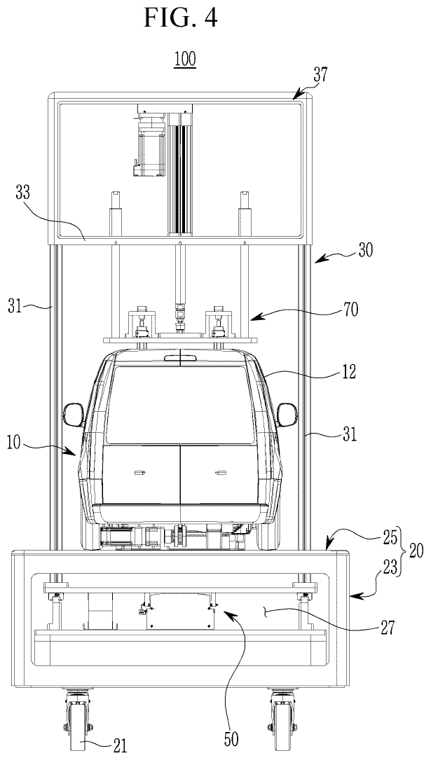

FIG. 3 is a side view illustrating a replaceable part replacement system of a vehicle according to an embodiment. FIG. 4 is a rear view illustrating a replaceable part replacement system of a vehicle according to an embodiment.

Referring to FIGS. 2-4, the station frame 20 according to an embodiment includes a station body 23 and a station base 25.

The station body 23 may be equipped with a frame body assembly in which beam-shaped frames and plates are combined to support the load of the vehicle 10.

The station body 23 includes an internal space 27. Additionally, casters 21, mentioned above, are mounted on the lower part of the station body 23.

The station base 25 is configured to support the underside of vehicle 10. The station base 25 is equipped with a plate type and is connected to the upper part of the station body 23.

The support frame 30 is configured to mount the gripper unit 70, which is described below.

The support frame 30 is installed on the station frame 20 so as to be able to move along the forward and backward direction of the vehicle 10.

The replaceable part replacement system 100 for a vehicle according to an embodiment includes a moving unit 50 to enable the support frame 30 to move the vehicle 10 along the forward and backward direction of the vehicle 10.

The moving unit 50 is installed in the station frame 20 and connected to the support frame 30. The moving unit 50 may be installed in the internal space 27 of the station body 23.

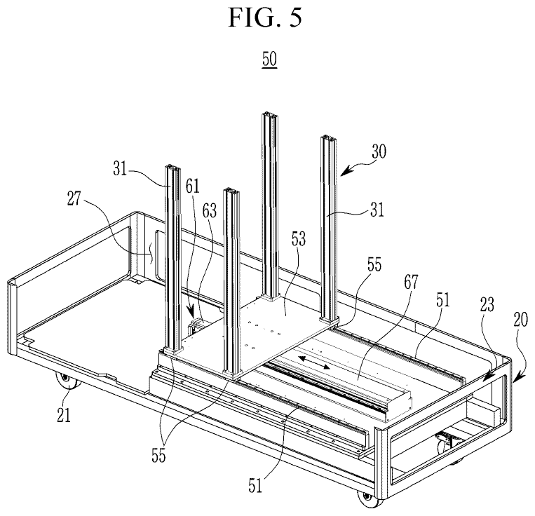

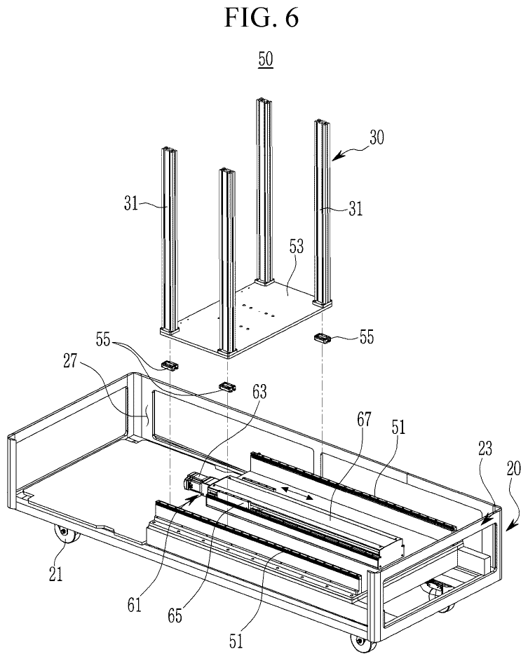

The configuration of the moving unit 50 is described in detail referring to FIGS. 5 and 6 below, and the configuration of the support frame 30 connected to the moving unit 50 is described first.

The support frame 30 according to an embodiment includes vertical frames 31, horizontal frames 33, and a mount plate 35 (see FIG. 2).

The vertical frames 31 are connected to the moving unit 50 and extend upwards. The vertical frames 31 are arranged in the vertical direction through slots 29 (see FIG. 2) formed in the station base 25. In other words, the vertical frames 31 are connected to the moving unit 50 in the internal space 27 of the station body 23 and extend upward through the slot 29.

The slot 29 is formed along the forward and backward directions on both sides of the length direction of the station base 25. The vertical frames 31 may be moved in the forward and backward direction along slot 29 by moving unit 50.

The horizontal frames 33 are arranged in a horizontal direction perpendicular to the vertical frames 31. Each horizontal frame 33 is joined horizontally to the upper portion of the vertical frames 31.

The horizontal frames 33 may form a box frame 37 on top of the vertical frames 31, as shown in the drawing.

The mount plate 35 (see FIG. 2) is attached to the horizontal frames 33 to mount the gripper unit 70, which is described below.

FIG. 5 is a perspective view illustrating a moving unit applied to a replaceable part replacement system of a vehicle according to an embodiment. FIG. 6 is a partially exploded perspective view illustrating a moving unit applied to a replaceable part replacement system for a vehicle according to an embodiment.

Referring to FIGS. 5 and 6, the moving unit 50 according to an embodiment includes guide rails 51, a moving plate 53, and sliders 55.

The guide rails 51 are installed in the internal space 27 of the station body 23. The guide rails 51 are arranged along the forward and backward directions on both sides of the vehicle width direction of the station body 23.

The moving plate 53 is slidably installed on the guide rails 51 and connected to the vertical frames 31 of the support frame 30. In one example, the moving plate 53 is provided as a quadrangle plate, and vertical frames 31 are joined along the vertical direction to each corner part of the moving plate 53.

This moving plate 53 is operationally connected to the first driver 61 installed in the station body 23 and can be reciprocally moved in the forward and backward direction along the guide rails 51 by the operation of the first driver 61.

The first driver 61 includes a first servo motor 63 capable of servo control of rotation speed and rotating direction, a lead screw (not shown) connected to the first servo motor 63, and a first moving body 65 connected to the lead screw.

The first moving body 65 is screw-connected to the lead screw and can be reciprocally moved in the forward and backward direction along the first guide structure 67 by rotation of the lead screw driven by the first servo motor 63. The first moving body 65 is connected to the moving plate 53.

The configuration and operation of the first driver 61 should be apparent to those having ordinary skill in the art, so a detailed description has been omitted.

The sliders 55 are fixed to the moving plate 53 and connected to the guide rails 51 so as to be able to slide along the forward and backward direction.

The sliders 55 are connected to the bottom surface of the moving plate 53. The sliders 55 are connected to the corners on both sides along the vehicle width direction of the moving plate 53.

Referring to FIGS. 2-4, in an embodiment, the gripper unit 70 is configured to grip and release the replaceable part 12 while the vehicle 10 is positioned on the station frame 20, and the engagements of the joint unit 15 between the fixed part 11 and the replaceable part 12, and the under body 1 and the replaceable part 12 are released.

In other words, the gripper unit 70 can unload the replaceable part 12 from the rear part of the under body 1 by gripping the replaceable part 12 separated from the fixed part 11. In addition, the gripper unit 70 can grip the replaceable part 12 on a separately provided replaceable part supply unit (not shown) and load the replaceable part 12 into the replaceable part supply unit.

Additionally, in an embodiment, the gripper unit 70 is configured to grip and release another replaceable part 12 supplied by the replaceable part supply unit.

In other words, the gripper unit 70 can grip another replaceable part 12 on the replaceable part supply unit and unload another replaceable part 12 from the replaceable part supply unit. Additionally, the gripper unit 70 can release another replaceable part 12 on the rear part of under body 1 and load another replaceable part 12 onto the rear part of under body 1.

These gripper units 70 are installed on the mount plate 35 (see FIG. 2) of the support frame 30 so as to enable reciprocal movement along the vertical direction.

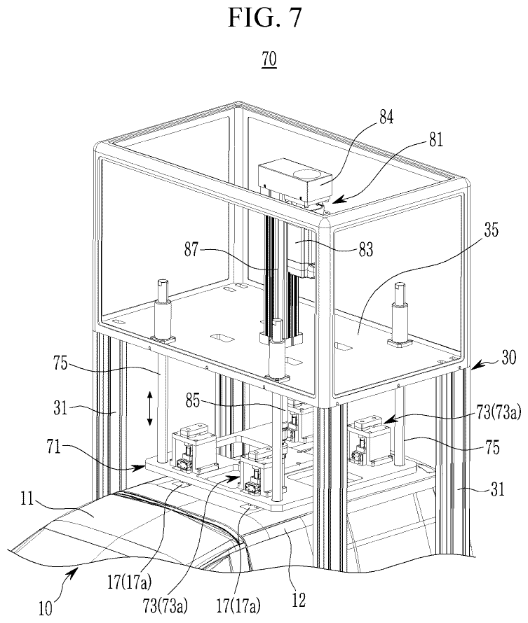

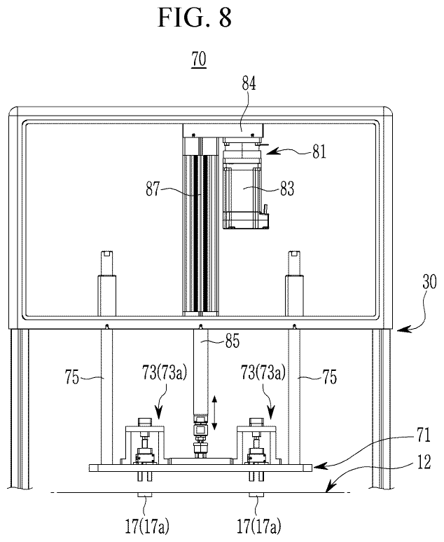

FIG. 7 is a perspective view illustrating a gripper unit applied to a replaceable part replacement system of a vehicle according to an embodiment. FIG. 8 is a front view illustrating a gripper unit applied to a replaceable part replacement system of a vehicle according to an embodiment.

Referring to FIGS. 7 and 8, the gripper unit 70 according to an embodiment includes a gripper moving member 71 and gripper modules 73.

The gripper moving member 71 is mounted movably in the vertical direction on the mount plate 35 of the support frame 30. In one example, the gripper moving member 71 may be provided in a plate shape.

The gripper moving member 71 can be reciprocally moved in the vertical direction via guide rods 75. The guide rods 75 are joined along the vertical direction to the corner portions of the gripper moving member 71 and are fitted vertically into the mount plate 35.

The gripper moving member 71 is operationally connected to a second driver 81 installed in the mount plate 35. The gripper moving member 71 can be reciprocally moved in the vertical direction through the guide rods 75 by operation of the second driver 81.

The second driver 81 includes a second servo motor 83 capable of servo control of rotation speed and rotating direction, a lead screw (not shown) connected to the second servo motor 83 via gear units 84, and a second moving body 85 connected to the lead screw.

The second moving body 85 is screw-coupled to the lead screw and can be reciprocally moved in the vertical direction along the second guide structure 87 according to rotation of the lead screw driven by the second servo motor 83. The second moving body 85 is connected to the gripper moving member 71.

The configuration and operation of the second driver 81 should be apparent to those having ordinary skill in the art, so a detailed description has been omitted.

In an embodiment, the gripper modules 73 are installed on the gripper moving member 71 to grip and release the upper portion of the replaceable part 12.

The gripper modules 73 can be connected or disconnected with gripper connecting portions 17 provided on the upper part of the replaceable part 12.

Each of the gripper connecting portions 17 may be an armature block 17a of steel material connected to a roof of a replaceable part 12.

Each of the gripper modules 73 may be a magnetic module 73a that can be coupled and/or decoupled from the armature block 17a by an electromagnetic force generated according to an external or internal power supply.

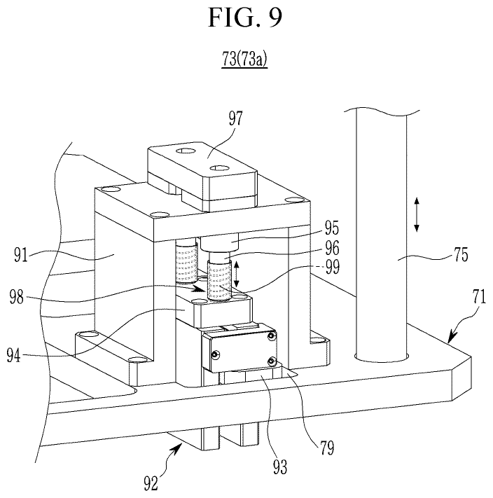

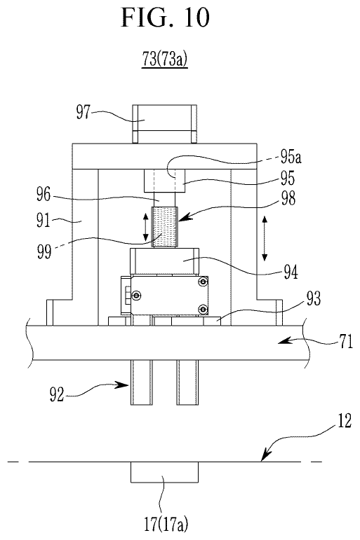

FIG. 9 is a perspective view illustrating a gripper module of a gripper unit applied to a replaceable part replacement system of a vehicle according to an embodiment. FIG. 10 is a front view illustrating a gripper module of a gripper unit applied to a replaceable part replacement system of a vehicle according to an embodiment.

Referring to FIGS. 9 and 10, each of the gripper modules 73 according to an embodiment includes a mounting bracket 91, a magnetic holder 92, and a coil 93.

The mounting bracket 91 is connected to the gripper moving member 71. The mounting bracket 91 is connected to the edge of a gripper mounting hole 79 formed in the gripper moving member 71.

The magnetic holder 92 is provided in the form of a block that exerts an electromagnetic force and can be coupled and/or decoupled from the gripper connecting portions 17, which are armature blocks 17a, by the electromagnetic force.

The magnetic holder 92 is mounted to the mounting bracket 91 through a magnetic bracket 94. The magnetic holder 92 passes through the gripper mounting hole 79 and protrudes downward from the gripper moving member 71.

The coil 93 can receive external or internal power supply and generate an electromagnetic force in the magnetic holder 92. The coil 93 is wound on the magnetic holder 92.

The gripper modules 73 according to an embodiment further include a guide bushing 95, a floating rod 96, a stopper block 97, and a damping member 98.

The guide bush 95 penetrates the upper part of the mounting bracket 91 and protrudes downward from that upper part. The guide bushing 95 is fixed to the upper part of the mounting bracket 91. The guide bushing 95 includes a hollow 95a formed along the vertical direction.

The floating rod 96 is inserted into the hollow 95a of the guide bushing 95 so as to be able to move in the vertical direction. The floating rod 96 is connected to the magnetic bracket 94.

The term ‘floating’ means that when the fixed first structure is pushed or pulled, the second structure related to the first structure moves (shifts) to match the position of the first structure due to the pushing or pulling force.

The floating rod 96 is configured to compensate for the roof height variation of the replaceable part 12, which is the gripping or releasing target of the gripper modules 73.

In other words, the floating rod 96 moves in the vertical direction inside the guide bushing 95 according to the roof height deviation of the replaceable part 12 and is designed to compensate for the roof height deviation of the replaceable part 12.

When the roof height deviation of the replaceable part 12 occurs, when the magnetic holder 92 contacts the gripper connecting portions 17 of the replaceable part 12, the floating rod 96 can move in the vertical direction due to the roof height deviation of the replaceable part 12.

The floating rod 96 penetrates the hollow 95a of the guide bushing 95 in the vertical direction and is connected to the magnetic bracket 94 through its lower part.

The stopper block 97 is configured to prevent the floating rod 96 from separating downward from the hollow 95a of the guide bushing 95.

The stopper block 97 is provided on the upper part of the guide bushing 95 and is connected to the upper part of the floating rod 96.

Additionally, the damping member 98 is configured to exert an elastic force on the magnetic holder 92. The damping member 98 can alleviate the gripping impact of the magnetic holder 92 and the gripper connecting portions 17. Additionally, the damping member 98 can restore the magnetic holder 92 to its original position when the replaceable part of the gripper modules 73 is released.

This damping member 98 is mounted on the floating rod 96 between the lower end of the guide bushing 95 and the upper end of the magnetic bracket 94. The damping member 98 may, in one example, include a compression coil spring 99.

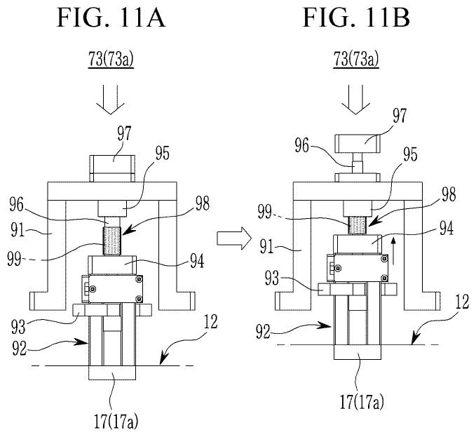

FIGS. 11A and 11B are drawings illustrating the operation of a replaceable part replacement system for a vehicle according to an embodiment.

Hereinafter, the operation of a replaceable part replacement system 100 of a vehicle according to an embodiment configured as described above is described in detail with reference to FIGS. 1-11B.

In an embodiment, a vehicle 10 is brought into a field work location (e.g., a replaceable part exchange location).

The fixed part 11 of the vehicle 10 is fixed to the front part of the under body 1, and the replaceable part 12 is connected to the fixed part 11 and the rear part of the under body 1 and by the joint unit 15.

The vehicle 10 may be a hailing vehicle or a high roof vehicle each including a cabin in fixed part 11 and replaceable part 12.

The vehicle 10 may be a delivery vehicle having a cabin formed to the fixed part 11 and a luggage room formed to the replaceable part 12.

The vehicle 10 may be a pickup vehicle or chassis cab vehicle having a cabin formed to the fixed part 11 and a deck formed to the replaceable part 12.

The vehicle 10 is positioned at a predetermined position in station frame 20. The roof of the replaceable part 12 of the vehicle 10 is provided with the gripper connecting portions 17, which are armature blocks 17a made of steel material, installed.

The connection between the fixed part 11 and the replaceable part 12 by joint unit 15 and the connection between the under body 1 and the replaceable part 12 by joint unit 15 are released.

The support frame 30 is connected to moving unit 50 installed in the station frame 20 and is moved backwards according to the operation of first driver 61.

Additionally, the gripper modules 73 of the gripper unit 70 are moved in the upward direction by the drive of the second driver 81 in the support frame 30. Each of the gripper modules 73 may be a magnetic module 73a.

The support frame 30 moves forward a predetermined distance by the driving of the first driver 61. The gripper modules 73 of the gripper unit 70 are positioned on the upper side of the replaceable part 12, i.e., on the upper side of the gripper connecting portions 17.

The predetermined movement distance of the above-mentioned support frame 30 is determined based on the position information of the gripper connecting portions 17 obtained from a sensor (not shown), and the first driver 61 is driven based on the position information of the gripper connecting portions 17.

The magnetic holder 92 of the gripper modules 73 is mounted on the mounting bracket 91 by the guide bushing 95, the floating rod 96, and the stopper block 97.

The gripper modules 73 move in the downward direction by the drive of the second driver 81.

Referring to FIG. 11A, the magnetic holder 92 of the gripper modules 73 contacts the gripper connecting portions 17 on the replaceable part 12. Additionally, the magnetic holder 92 may press the gripper connecting portions 17 in a downward direction according to the operation of the second driver 81.

Referring to FIG. 11B, when a roof height deviation occurs in the replaceable part 12, the floating rod 96 can compensate for the height deviation together with the magnetic holder 92. The magnetic holder 92 can move in the upward direction while compressing the damping member 98.

Then, external or internal power is applied to coil 93 of the gripper modules 73. Then, the magnetic holder 92 generates an electromagnetic force.

Accordingly, the magnetic holder 92 is connected to the gripper connecting portions 17 of the replaceable part 12 by electromagnetic force. In other words, the magnetic holder 92 grips the gripper connecting portions 17 of the replaceable part 12 by electromagnetic force.

Next, as described above, with the gripper modules 73 gripping the replaceable part 12, the gripper modules 73 move in the upward direction by the operation of the second driver 81. Accordingly, the replaceable part 12 gripped by the gripper modules 73 is unloaded from the rear part of the under body 1 and moved in the upward direction.

Next, the support frame 30 moves rearward by the drive of the first driver 61. Then, since the gripper unit 70 is installed on the support frame 30, the replaceable part 12 is moved rearward according to the movement of the support frame 30.

As shown above, the replaceable part 12 moved rearward is positioned on the upper side of the replaceable part supply unit (not shown). Then, the gripper modules 73 move downward by the drive of the second driver 81 and load the replaceable part 12 onto the replaceable part supply unit. After this, when the power applied to coil 93 of the gripper modules 73 is cut off, the gripper modules 73 release the replaceable part 12 on the replaceable part supply unit.

As described above, with the replaceable part 12 of vehicle 10 removed, the gripper modules 73 grip another replaceable part 12 on the replaceable part supply unit and unload another replaceable part 12 from the replaceable part supply unit.

Then, the gripper module 73 releases another replaceable part 12 on the rear part of under body 1 and load another replaceable part 12 onto the rear part of under body 1.

The loading and unloading of the other replaceable part 12 can be implemented by the raising and lowering movements of the gripper modules 73. The gripping and releasing of the other replaceable part 12 can be implemented by energizing and de-energizing the coil 93 of the gripper modules 73.

Therefore, the replaceable part replacement system 100 of a vehicle according to an embodiment can replace the replaceable part 12 of the vehicle 10 according to the intended use through a series of processes as described above.

The replaceable part replacement system 100 of a vehicle according to an embodiment described so far can easily replace the replaceable part 12, which can be changed according to the intended use of the vehicle 10, in the field (e.g., in a service zone).

Accordingly, the vehicle replaceable part replacement system 100 according to an embodiment can activate the use of PBVs that provide various customized services to users, increase the utilization of PBVs, and contribute to the standardization of future new businesses utilizing PBVs and securing a competitive edge.

In addition, according to the vehicle replaceable part replacement system 100 according to an embodiment, the replaceable part 12 of the vehicle 10 can be easily replaced, so the A/S efficiency of the vehicle 10 can be improved and the A/S waiting time can be reduced.

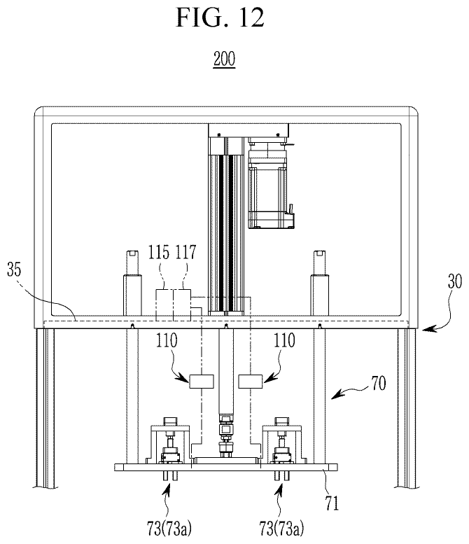

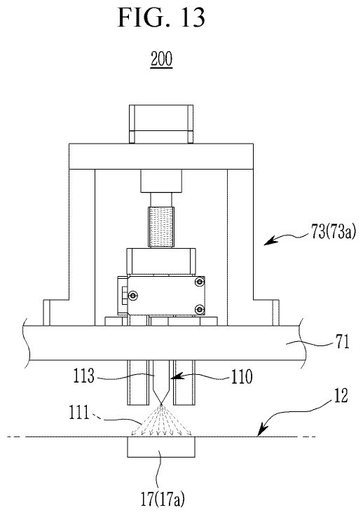

FIG. 12 is a front view illustrating a replaceable part replacement system of a vehicle according to another embodiment. FIG. 13 is a drawing illustrating the operation of a replaceable part replacement system for a vehicle according to another embodiment. For convenience of understanding, the same drawing reference numerals are given to components that are identical to those in the electrical embodiment.

A replaceable part replacement system 200 for a vehicle according to another embodiment of the present disclosure, referring to FIGS. 12 and 13, may further include a cleaning module 110 installed in the gripper unit 70.

In an embodiment, the cleaning module 110 is configured to clean the gripper connecting portions 17 of the replaceable part 12 by spraying washer fluid 111 onto the gripper connecting portions 17.

The cleaning module 110 includes a cleaning nozzle 113. The cleaning nozzle 113 is configured to spray washer fluid 111 onto the gripper connecting portions 17. The cleaning nozzle 113 may, in one example, be installed on the gripper moving member 71 of the gripper unit 70.

The cleaning nozzles 113 can spray water stored in the water tank 115 onto the gripper connecting portions 17 by compressed air provided from the compressor 117. In other words, the washer fluid 111 may include water.

The water tank 115 and the compressor 117 can be installed on the mount plate 35 of the support frame 30, in one example.

According to the replaceable part replacement system 200 of a vehicle according to another embodiment, when the gripper connecting portions 17 of the replaceable part 12 are contaminated by various foreign substances, washer fluid 111 is sprayed onto the gripper connecting portions 17 of the replaceable part 12 through the cleaning nozzle 113.

Then, various foreign substances are removed from the gripper connecting portions 17 by washer fluid 111 sprayed through the cleaning nozzle 113.

Accordingly, the replaceable part replacement system 200 of a vehicle according to another embodiment can secure a bonding force between the gripper modules 73, which is a magnetic module 73a, and the gripper connecting portions 17, which is an armature block 17a, by cleaning the gripper connecting portions 17 on the replaceable part 12 with washer fluid 111.

The remaining configuration and operation of the replaceable part replacement system 200 of the vehicle according to another embodiment as described above are the same as the embodiment described above, so a further detailed description has been omitted.

Although the embodiments of the present disclosure have been described above, the present disclosure is not limited thereto, and various modifications may be made within the scope of the claims, the detailed description of the present disclosure, and the attached drawings, which also fall within the scope of the present disclosure.

### DESCRIPTION OF SYMBOLS

1: under body
3: upper body
10: vehicle
11: fixed part
12: replaceable part
15: joint unit
17: gripper connecting portion
17a: armature block
20: station frame
21: caster
23: station body
25: station base
27: internal space
29: slot
30: support frame
31: vertical frame
33: horizontal frame
35: mount plate (i.e., mounting plate)
37: box frame
50: moving unit
51: guide rail
53: moving plate
55: slider
61: first driver
63: first servo motor
65: first moving body
67: first guide structure
70: gripper unit
71: gripper moving member
73: gripper module
73a: magnetic module
75: guide rod
79: gripper mounting hole
81: second driver
83: second servo motor
85: second moving body
87: second guide structure
91: mounting bracket
92: magnetic holder
93: coil
94: magnetic bracket
95: guide bush
96: floating rod
97: stopper block
98: damping member
99: compression coil spring
100,
200: replaceable part replacement system
110: cleaning module
111: washer fluid
113: cleaning nozzle
115: water tank
117: compressor

What is claimed is:

1. A replaceable part replacement system for a vehicle, the replaceable part replacement system comprising:
a station frame on which the vehicle, including a fixed part fixed to an under body and a replaceable part removable from the fixed part, is positioned;
a support frame installed on the station frame to be movable along a forward and backward direction of the vehicle; and
a gripper unit installed in the support frame to be movable in a vertical direction for gripping and releasing the replaceable part.

2. The replaceable part replacement system of claim 1, further comprising a moving unit installed on the station frame and connected to the support frame to move the support frame along the forward and backward direction of the vehicle.

3. The replaceable part replacement system of claim 2, wherein the moving unit comprises:
at least one guide rail arranged along the forward and backward direction of the vehicle on the station frame; and
a moving plate connected to a first driver installed in the station frame, slidably installed on the at least one guide rail, and connected to the support frame.

4. The replaceable part replacement system of claim 3, wherein the moving unit further comprises at least one slider fixed to the moving plate and slidably connected to at least one guide rail.

5. The replaceable part replacement system of claim 1, wherein the station frame comprises:
a station body having an internal space; and
a station base connected to an upper part of the station body to support the vehicle.

6. The replaceable part replacement system of claim 5, wherein the support frame comprises:
at least one vertical frame that is connected to a moving unit installed in the internal space of the station body and extends upward through a slot formed in the station base;
at least one horizontal frame connected in a horizontal direction to the at least one vertical frame; and
a mounting plate attached to the at least one horizontal frame, wherein the gripper unit is mounted on the mounting plate.

7. The replaceable part replacement system of claim 1, wherein the gripper unit comprises:
a gripper moving member connected to a second driver installed in the support frame and mounted on the support frame to be movable in the vertical direction; and
at least one gripper module installed on the gripper moving member to be coupled with at least one gripper connecting portion provided on the replaceable part.

8. The replaceable part replacement system of claim 7, wherein:
the at least one gripper connecting portion is an armature block of a steel material connected to a roof of the replaceable part; and
the at least one gripper module is a magnetic module that can be coupled to the armature block by electromagnetic force.

9. The replaceable part replacement system of claim 7, wherein the at least one gripper module comprises:
a mounting bracket connected to the support frame;
a magnetic holder mounted via a magnetic bracket to the mounting bracket; and
a coil wound on the magnetic holder.

10. The replaceable part replacement system of claim 9, wherein the at least one gripper module further comprises:
a guide bushing connected to the mounting bracket; and
a floating rod connected to the guide bushing to be movable in the vertical direction, wherein the floating rod is connected to the magnetic bracket.

11. The replaceable part replacement system of claim 10, wherein the at least one gripper module further comprises a stopper block provided on an upper part of the guide bushing and connected to the floating rod.

12. The replaceable part replacement system of claim 10, wherein the at least one gripper module further comprises a damping member mounted on the floating rod between the guide bushing and the magnetic bracket.

13. The replaceable part replacement system of claim 12, wherein the damping member is a compression coil spring.

14. The replaceable part replacement system of claim 1, wherein:
the replaceable part is provided with at least one gripper connecting portion that is gripped by the gripper unit; and
a cleaning module is installed in the gripper unit to spray washer fluid onto at least one gripper connecting portion.

15. The replaceable part replacement system of claim 14, wherein the cleaning module comprises a cleaning nozzle configured to spray water stored in a water tank to at least one gripper connecting portion by compressed air provided from a compressor.

16. The replaceable part replacement system of claim 1, wherein the vehicle is a PBV (Purpose Built Vehicle).
